(19) United States
(12) Patent Application Publication
(10) Pub. No.: US 2025/0368071 A1
(43) Pub. Date: Dec. 4, 2025

(54) CONNECTING DEVICE AND CHARGING DEVICE INCLUDING THE SAME

(71) Applicant: LG ELECTRONICS INC., Seoul (KR)

(72) Inventors: Sunghoon KANG, Seoul (KR); Sunghwan OH, Seoul (KR); Myoungku LEE, Seoul (KR); Jiho LEE, Seoul (KR); Junyeop JEONG, Seoul (KR)

(73) Assignee: LG ELECTRONICS INC., Seoul (KR)

(21) Appl. No.: 18/778,811

(22) Filed: Jul. 19, 2024

(30) Foreign Application Priority Data
Jun. 3, 2024 (WO) PCT/KR2024/007545

(51) Int. Cl. B60L 53/30; B60L 53/18; H02G 11/00

(52) U.S. Cl. CPC B60L 53/30; B60L 53/18; H02G 11/006

(57) ABSTRACT

A connecting device includes a wire withdrawn from and retracted into a retractor, a cable ring fastened to the wire and surrounding a charging cable, and a cover bracket covering the charging cable and the cable ring and allowing the wire passing therethrough. The cable ring includes a wire groove formed on an outer circumferential surface of the cable ring to wind the wire therearound. The connecting device may stably connect the wire withdrawn from and retracted into the retractor to the charging cable.

### CROSS-REFERENCE TO RELATED APPLICATION(S)

Pursuant to 35 U.S.C. § 119, this application claims the benefit of earlier filing date and right of priority to International Patent Application No. PCT/KR2024/007545, filed on Jun. 3, 2024, the contents of which are all incorporated by reference herein in their entirety.

### BACKGROUND

### 1. Field

The disclosure relates to a connecting device for stably connecting a wire withdrawn from and retracted into a retractor to a charging cable, and a charging device including the same.

### 2. Description of Related Art

In general, an electric vehicle (EV) has not been put into practical use for a long time because of problems such as a great weight of a battery mounted in the vehicle and a time it takes to charge when compared to a gasoline or diesel vehicle. However, recently, because of a depletion of fossil energy and environmental pollution, interest in the electric vehicle that does not use the fossil energy but uses electric energy has increased, and research and development on the electric vehicle have been actively conducted.

As a result, popularization of the electric vehicle has been increasing recently. The electric vehicle has a battery that supplies power for operation thereof, and has a structure in which the power is stored in the battery. Therefore, to continuously operate the electric vehicle, the battery must be charged. Accordingly, an infrastructure for charging the electric vehicle is needed, and fixed standing charging facilities are being established in various locations to meet an increasing demand for the electric vehicle.

In this regard, a charging device of the electric vehicle is an element for building a stable charging infrastructure that maintains electrical stability and long-term lifespan. This is because the charging device of the electric vehicle is mainly installed outdoors, such as a parking lot of a public building or a park, a highway rest area, and an apartment complex.

Particularly for an electric vehicle that requires frequent charging, a charging cable connected to a charger should be of a certain length, for the convenience of a user. Accordingly, there is a need for a means for stably mounting the charging cable.

The charging cable has one end connected to a body that supplies power to the charging cable, and the other end connected to the charger which is coupled to an electric vehicle when the electric vehicle is charged.

Therefore, to minimize damage to the above-described charging cable of a certain length, caused by friction with the floor, there is a need for a device for mounting a middle part of the charging cable on the body. Further, there is a need for a method of stably mounting the charging cable by minimizing the possibility of breakage of the device for mounting the charging cable.

### SUMMARY

An aspect of the disclosure is to provide a connecting device and a charging device including the same, and more particularly, to provide a connecting device for stably connecting a wire withdrawn from and retracted into a retractor to a charging cable, and a charging device including the same

Another aspect of the disclosure is to provide a connecting device which may minimize the possibility of damage by securing structural rigidity through a cable ring for fastening a wire to a charging cable and a cover bracket structure covering the cable ring, and a charging device including the same.

Additional aspects will be set forth in part in the description which follows and, in part, will be apparent from the description, or may be learned by practice of the presented embodiments of the disclosure.

Provided is a connecting device including a wire withdrawn from and retracted into a retractor, a cable ring fastened to the wire and surrounding a charging cable, and a cover bracket covering the charging cable and the cable ring and allowing the wire passing therethrough. The cable ring includes a wire groove formed on an outer circumferential surface of the cable ring to wind the wire therearound.

The cable ring may include a C-shape with both ends thereof spaced apart from each other.

The wire may include a locking loop formed at one end thereof, and the locking loop may be located between both ends of the cable ring.

The cover bracket may include a seating groove formed at a center thereof, in which the cable ring is seated.

The connecting device may further include a first fixing rib inserted into the seating groove, contacting the cable ring, and preventing the cable ring from moving.

The cover bracket may be bent in the same direction from a center thereof toward both sides thereof.

The cover bracket may include a fixing groove formed at a center thereof, in which the passing wire is located.

The connecting device may further include a second fixing rib inserted into the fixing groove, contacting the wire, and preventing the wire from moving.

The cover bracket may include a first cover bracket and a second cover bracket structured to be coupled to each other, and the first cover bracket and the second cover bracket may include a rivet fastener formed on bottoms thereof in a direction parallel to the charging cable.

The rivet fastener may include a pair of first rivet fasteners formed spaced apart from each other on the first cover bracket, and a second rivet fastener formed on the second cover bracket and located between the pair of first rivet fasteners.

The connecting device may further include a rivet passing through the pair of first rivet fasteners and the second rivet fastener.

Provided is a charging device including a body supplying power to a charging cable, a retractor located in an upper part of the body, and a connecting device connecting the charging cable to the retractor. The connecting device includes a wire withdrawn from and retracted into the retractor, a cable ring fastened to the wire and surrounding the charging cable, and a cover bracket covering the charging cable and the cable ring and allowing the wire passing therethrough. The cable ring includes a wire groove formed on an outer circumferential surface of the cable ring to wind the wire therearound.

The cable ring may include a C-shape with both ends thereof spaced apart from each other.

The wire may include a locking loop formed at one end thereof, and the locking loop may be located between both ends of the cable ring.

The cover bracket may include a seating groove formed at a center thereof, in which the cable ring is seated.

The connecting device may further include a first fixing rib inserted into the seating groove, contacting the cable ring, and preventing the cable ring from moving.

The cover bracket may be bent in the same direction from a center thereof toward both sides thereof.

The cover bracket may include a fixing groove formed at a center thereof, in which the passing wire is located.

The connecting device may further include a second fixing rib inserted into the fixing groove, contacting the wire, and preventing the wire from moving.

The cover bracket may include a first cover bracket and a second cover bracket structured to be coupled to each other, and the first cover bracket and the second cover bracket may include a rivet fastener formed on bottoms thereof in a direction parallel to the charging cable.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a charging device including a connecting device according to an embodiment of the disclosure;

FIG. 2 is a diagram illustrating a connecting device according to an embodiment of the disclosure;

FIG. 3 is a diagram illustrating the internal structure of a connecting device according to an embodiment of the disclosure;

FIG. 4 is an exploded diagram illustrating a connecting device according to an embodiment of the disclosure;

FIG. 5 is a diagram illustrating a first cover bracket in a connecting device according to an embodiment of the disclosure;

FIG. 6 is a diagram illustrating a second cover bracket in a connecting device according to an embodiment of the disclosure;

FIG. 7 is a diagram illustrating a cover bracket which covers a charging cable and a cable ring and through which a wire passes in a connecting device according to an embodiment of the disclosure; and

FIG. 8 is a diagram illustrating a rivet fastener formed on the bottom of a cover bracket in a connecting device according to an embodiment of the disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

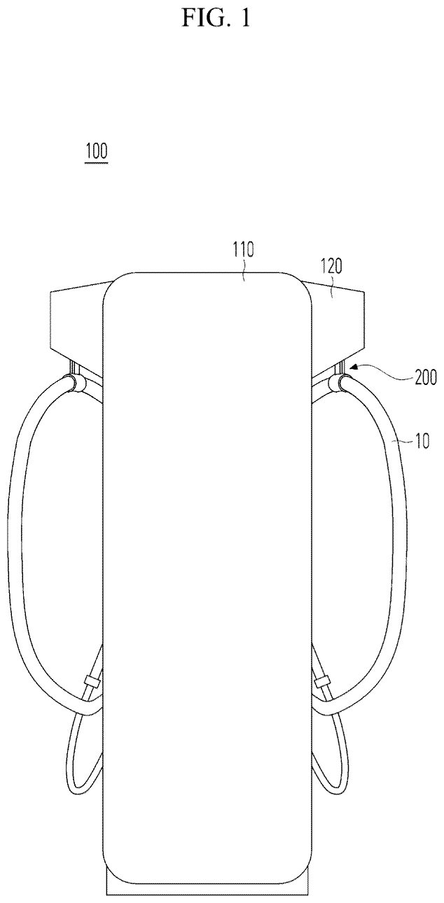

FIG. 1 is a diagram illustrating a charging device 100 including a connecting device 200 according to an embodiment of the disclosure.

The charging device 100 according to an embodiment of the disclosure includes a body 110 that supplies power to a charging cable 10, a retractor 120 located in an upper part of the body 110, and a connecting device 200 that connects the charging cable 10 to the retractor 120.

As described before, as the demand for electric vehicles (EVs) increases, infrastructure for charging electric vehicles is needed, and charging devices 100 as illustrated in FIG. 1 are installed in various locations.

Particularly for an electric vehicle that requires frequent charging, the charging cable 10 connected to a charger should be of a certain length, for user convenience. Accordingly, a means for stably mounting the charging cable 10 is needed. The charging cable 10 has one end connected to the body 110 that supplies power to the charging cable 10 and the other end connected to the charger which is coupled to an electric vehicle when the electric vehicle is charged.

Therefore, to minimize damage to the charging cable 10 of a certain length, caused by friction with the floor, it is necessary to mount a middle part of the charging cable 10 on the body 110, and for this purpose, the retractor 120 may be located in the upper part of the body 110.

The charging device 100 according to an embodiment of the disclosure may be provided with the connecting device 200 connecting the charging cable 10 to the retractor 120. As the charging cable 10 is mounted stably by the connecting device 200, damage to the charging cable 10 may be minimized, and user convenience for charging an electric vehicle may be improved. The connecting device 200 provided in the charging device 100 of the disclosure will be described in more detail.

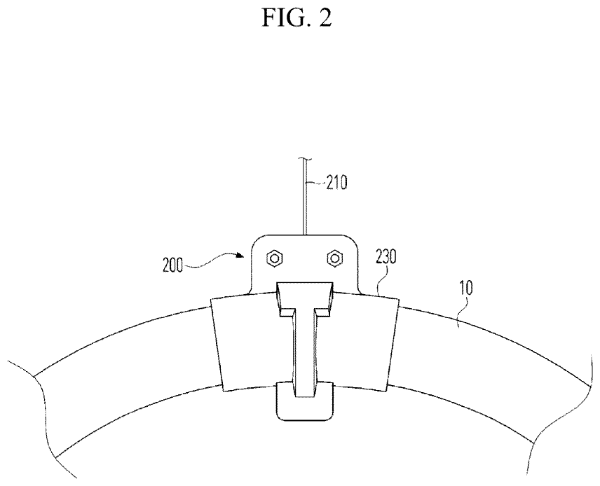

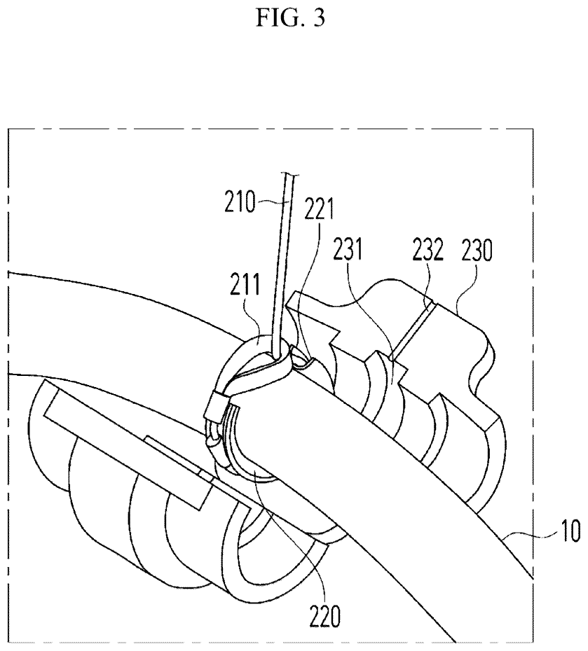

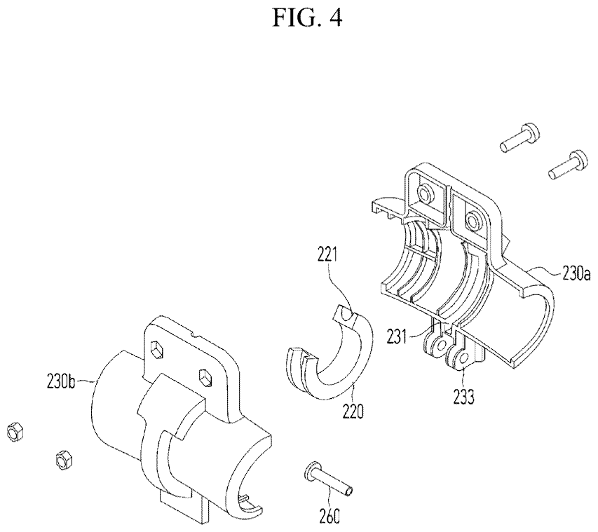

FIG. 2 is a diagram illustrating the connecting device 200 according to an embodiment of the disclosure. FIG. 3 is a diagram illustrating the internal structure of the connecting device 200 according to an embodiment of the disclosure. FIG. 4 is an exploded diagram illustrating the connecting device 200 according to an embodiment of the disclosure.

Referring to FIGS. 2 to 4 together, the connecting device 200 according to an embodiment of the disclosure may include a wire 210, a cable ring 220, and a cover bracket 230. The wire 210 is wound within the retractor 120 described above with reference to FIG. 1, and may be withdrawn from and retracted into the retractor 120. The cable ring 220, which is a structure to be fastened to the wire 210, may allow the charging cable 10 to pass therethrough and surround the outer circumferential surface of the charging cable 10.

Further, the cover bracket 230 may cover the charging cable 10 and the cable ring 220. The wire 210 may pass upward through the cover bracket 230. Particularly, the cable ring 220 may include a wire groove 221 formed on the outer circumferential surface thereof, so that the wire 210 is wound around the wire groove 221.

Therefore, the connecting device 200 according to an embodiment of the disclosure is not a structure which simply connects the wire 210 to a cover member covering the charging cable 10.

That is, the connecting device 200 according to an embodiment of the disclosure may be structured to fasten the wire 210 to the charging cable 10 by winding the wire 210 around the wire groove 221 formed on the outer circumferential surface of the cable ring 220 surrounding the charging cable 10, and covering the charging cable 10 and the cable ring 220 by the cover bracket 230, while allowing the wire 210 to pass through the cover bracket 230, thereby stably connecting the wire 210 to the charging cable 10.

Further, when the wire 210 is simply connected to the cover member covering the charging cable 10, damage to the cover member may disconnect the wire 210 from the charging cable 10, resulting in inconvenience for the user.

Accordingly, to solve this problem, the connecting device 200 according to an embodiment of the disclosure may fasten the wire 210 to the cable ring 220 formed to surround the charging cable 10, and protect the cable ring 220 fastened to the wire 210 from external force by the cover bracket 230. Therefore, the charging cable 10 and the wire 210 may be advantageously connected even when the cover bracket 230 is damaged. Additionally, the possibility of damage may be minimized by securing structural rigidity.

Further, the cable ring 220 may have a C-shape with both ends spaced apart from each other in the connecting device 200 according to an embodiment of the disclosure, as illustrated in FIG. 3. The wire 210 may include a locking loop 211 formed at one end thereof, and the locking loop 211 may be located between both ends of the cable ring 220.

That is, the wire 210 may be wound around the wire groove 221 formed on the outer circumferential surface of the cable ring 220 through the loop 211 formed at the end of the wire 210 to support the charging cable 10.

Further, as the cable ring 220 is C-shaped with both ends thereof spaced apart from each other, it may facilitate coupling between the charging cable 10 and the cable ring 220.

Further, the locking loop 211 is located between both ends of the C-shaped cable ring 220, which may improve the structural stability of the wire 210 wound around the cable ring 220 and fastened to the charging cable 10.

The cover bracket 230 according to an embodiment of the disclosure may include a seating groove 231 formed at a center thereof, in which the cable ring 220 is seated. Further, the cover bracket 230 may include a fixing groove 232 formed at the center thereof, in which the passing wire 210 is located. Accordingly, the cover bracket 230 may serve to protect the charging cable 10, the cable ring 220, and the wire 210 wound around the cable ring 220 from external force.

Further, the cover bracket 230 may be bent in the same direction from the center toward both sides in the connecting device 200 according to an embodiment of the disclosure. As described above with reference to FIGS. 1 and 2, this is because the connecting device 200 of the disclosure is located at the middle part of the charging cable 10 of a certain length and connected to the retractor located in the upper part of the body 110.

Therefore, the curved shape of the cover bracket 230 described above is intended to more stably hold the charging cable 10 in consideration of load applied to the charging cable 10. In addition, the risk of damage such as breakage of the charging cable 10 may be minimized through the curved shape of the cover bracket 230.

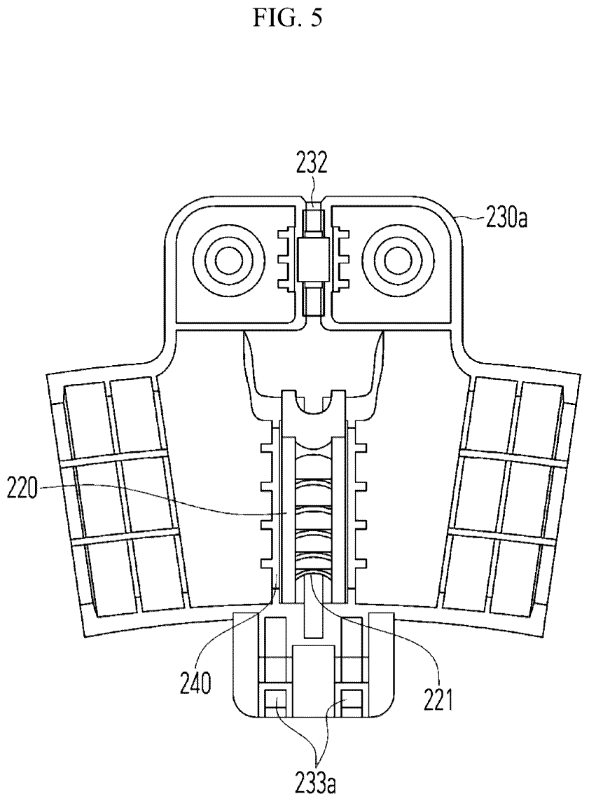

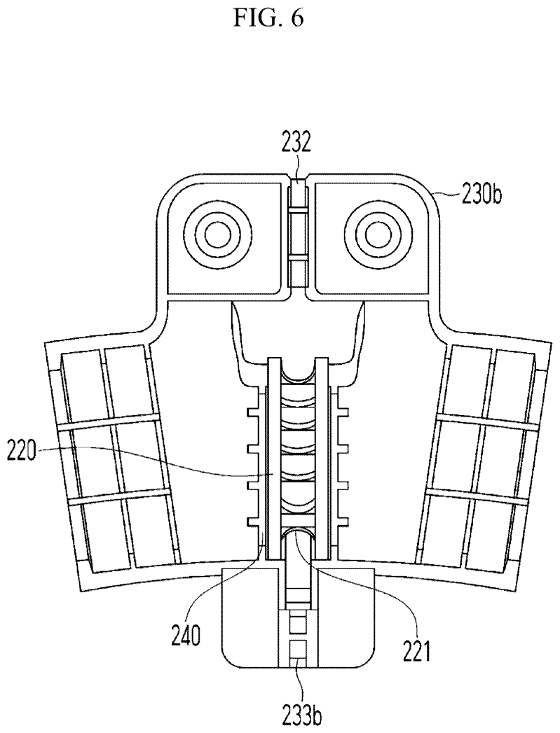

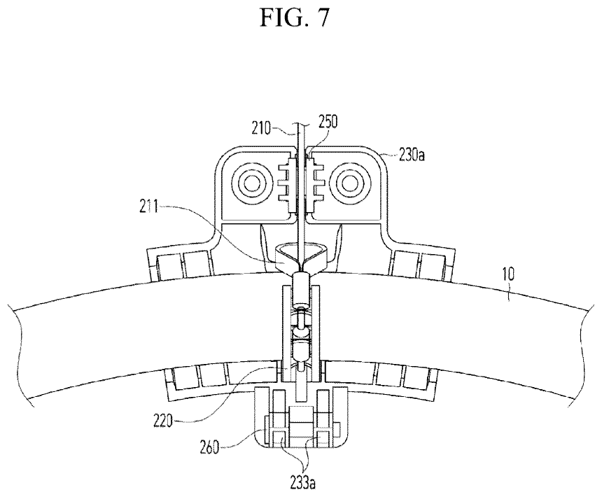

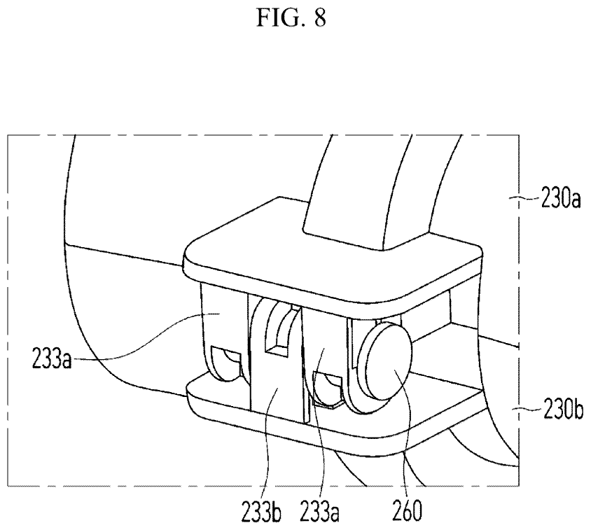

FIG. 5 is a diagram illustrating a first cover bracket 230a in the connecting device 200 according to an embodiment of the disclosure. FIG. 6 is a diagram illustrating a second cover bracket 230b in the connecting device 200 according to an embodiment of the disclosure. FIG. 7 is a diagram illustrating the cover bracket 230 which covers the charging cable 10 and the cable ring 220 and through which the wire 210 passes in the connecting device 200 according to an embodiment of the disclosure. FIG. 8 is a diagram illustrating a rivet fastener 233 formed in a lower part of the cover bracket 230 in the connecting device 200 according to an embodiment of the disclosure.

In the connecting device 200 according to an embodiment of the disclosure, the cover bracket 230 may include the first cover bracket 230a and the second cover bracket 230b structured to be coupled to each other. Referring to FIGS. 3 and 4 together, the cover bracket 230 may be open and closed by the coupling structure between the first cover bracket 230a and the second cover bracket 230b, which may facilitate repair and maintenance when the wire 210 is fastened to the charging cable 10.

Further, the first cover bracket 230a and the second cover bracket 230b may include the rivet fastener 233 formed on bottoms thereof in a direction parallel to the charging cable 10 in the connecting device 200 according to an embodiment of the disclosure. The rivet fastener 233 may include a pair of first rivet fasteners 233a formed spaced apart from each other on the first cover bracket 230a. Further, the rivet fastener 233 may include a second rivet fastener 233b formed on the second cover bracket 230b and located between the pair of first rivet fasteners 233a. Additionally, the connecting device 200 according to an embodiment of the disclosure may further include a rivet 260 passing through the pair of first rivet fasteners 233a and the second rivet fastener 233b.

Referring to FIG. 8 together, as the second rivet fastener 233b is located between the pair of first rivet fasteners 233a, and the rivet 260 passes through the pair of first rivet fasteners 233a and the second rivet fastener 233a as described above, the first cover bracket 230a and the second cover bracket 230b may be coupled to each other more firmly. Further, the first cover bracket 230a and the second cover bracket 230b may be structured to be open and closed through the rivet 260. As described above, this may facilitate repair and maintenance when the wire 210 and the charging cable 10 are fastened to each other.

Referring to FIGS. 3 to 7 together, the connecting device 200 according to an embodiment of the disclosure may further include a first fixing rib 240 which is inserted into the seating groove 231, contacts the cable ring 220, and prevents the cable ring 220 from moving. The first fixing rib 240 may be in close contact with the seating groove 231 and the cable ring 220, thereby preventing the cable ring 220 from moving to stably support the charging cable 10.

The connecting device 200 according to an embodiment of the disclosure may further include a second fixing rib 250 which is inserted into the fixing groove 232, contacts the wire 210, and prevents the wire 210 from moving. The second fixing rib 250 may be in close contact with the fixing groove 232 and the wire 210, thereby preventing the wire 210 from moving to stably support the charging cable 10.

That is, as the connecting device 200 according to an embodiment of the disclosure prevents the cable ring 220 and the wire 210 located inside the cover bracket 230 from moving by the first fixing rib 240 and the second fixing rib 250, the retractor 120 and the charging cable 10 may be maintained stably connected even if the charging cable 10 moves. Accordingly, when an electric vehicle is charged by the charging device 100 of the disclosure, user convenience may be improved.

As is apparent from the foregoing description, the connecting device and the charging device including the same according to the disclosure may stably connect the wire withdrawn from and retracted into the retractor to the charging cable. Further, structural rigidity may be secured through the cable ring for fastening the wire to the charging cable and the cover bracket structure covering the cable ring, thereby minimizing the possibility of damage.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A connecting device comprising:
a wire withdrawn from and retracted into a retractor;
a cable ring fastened to the wire and surrounding a charging cable; and
a cover bracket covering the charging cable and the cable ring and allowing the wire passing therethrough,
wherein the cable ring includes a wire groove formed on an outer circumferential surface of the cable ring to wind the wire therearound.

2. The connecting device of claim 1, wherein the cable ring includes a C-shape with both ends thereof spaced apart from each other.

3. The connecting device of claim 2, wherein the wire includes a locking loop formed at one end thereof, and
wherein the locking loop is located between both ends of the cable ring.

4. The connecting device of claim 1, wherein the cover bracket includes a seating groove formed at a center thereof, in which the cable ring is seated.

5. The connecting device of claim 4, further comprising a first fixing rib inserted into the seating groove, contacting the cable ring, and preventing the cable ring from moving.

6. The connecting device of claim 1, wherein the cover bracket is bent in the same direction from a center thereof toward both sides thereof.

7. The connecting device of claim 1, wherein the cover bracket includes a fixing groove formed at a center thereof, in which the passing wire is located.

8. The connecting device of claim 7, further comprising a second fixing rib inserted into the fixing groove, contacting the wire, and preventing the wire from moving.

9. The connecting device of claim 1, wherein the cover bracket includes a first cover bracket and a second cover bracket structured to be coupled to each other, and
wherein the first cover bracket and the second cover bracket include a rivet fastener formed on bottoms thereof in a direction parallel to the charging cable.

10. The connecting device of claim 9, wherein the rivet fastener includes:
a pair of first rivet fasteners formed spaced apart from each other on the first cover bracket; and
a second rivet fastener formed on the second cover bracket and located between the pair of first rivet fasteners.

11. The connecting device of claim 10, further comprising a rivet passing through the pair of first rivet fasteners and the second rivet fastener.

12. A charging device comprising:
a body supplying power to a charging cable;
a retractor located in an upper part of the body; and
a connecting device connecting the charging cable to the retractor,
wherein the connecting device includes:
a wire withdrawn from and retracted into the retractor;
a cable ring fastened to the wire and surrounding the charging cable; and
a cover bracket covering the charging cable and the cable ring and allowing the wire passing therethrough, and
wherein the cable ring includes a wire groove formed on an outer circumferential surface of the cable ring to wind the wire therearound.

13. The charging device of claim 12, wherein the cable ring includes a C-shape with both ends thereof spaced apart from each other.

14. The charging device of claim 13, wherein the wire includes a locking loop formed at one end thereof, and
wherein the locking loop is located between both ends of the cable ring.

15. The charging device of claim 12, wherein the cover bracket includes a seating groove formed at a center thereof, in which the cable ring is seated.

16. The charging device of claim 15, wherein the connecting device further includes a first fixing rib inserted into the seating groove, contacting the cable ring, and preventing the cable ring from moving.

17. The charging device of claim 12, wherein the cover bracket is bent in the same direction from a center thereof toward both sides thereof.

18. The charging device of claim 12, wherein the cover bracket includes a fixing groove formed at a center thereof, in which the passing wire is located.

19. The charging device of claim 18, wherein the connecting device further includes a second fixing rib inserted into the fixing groove, contacting the wire, and preventing the wire from moving.

20. The charging device of claim 12, wherein the cover bracket includes a first cover bracket and a second cover bracket structured to be coupled to each other, and
wherein the first cover bracket and the second cover bracket include a rivet fastener formed on bottoms thereof in a direction parallel to the charging cable.
